(19) United States
(12) Patent Application Publication
(10) Pub. No.: US 2015/0369389 A1
(43) Pub. Date: Dec. 24, 2015

(54) FLUID VALVE AND SHAFT SEALING STRUCTURE THEREOF

(71) Applicant: JDV CONTROL VALVES CO., LTD, Yangmei City (TW)

(72) Inventor: Andy FAN, Yangmei City, Taoyuan County (TW)

(21) Appl. No.: 14/542,107

(22) Filed: Nov. 14, 2014

(30) Foreign Application Priority Data
Jun. 24, 2014 (TW) 103121660

(51) Int. Cl. F16K 31/44; F16K 1/36; F16K 5/06; F16K 1/226

(52) U.S. Cl. CPC F16K 31/44; F16K 1/2261; F16K 1/36; F16K 5/0663

(57) ABSTRACT

A fluid valve includes a valve body, a shaft and a valve disc. A shaft seal groove and a valve disc groove, which are in communication with each other, are provided in the valve body. The valve disc is disposed in the valve disc groove. A modular shaft sealing structure is provided in the shaft seal groove, and formed by sequentially stacked shaft seal rings, shaft rings and spring. The inner sides of these components are combined to be an accommodating space, in which the shaft is allowed to be accommodated. The modular shaft sealing structure of the present invention may be detachable, and can be integrally replaced, enabling more convenient replacement of components in the shaft sealing structure, so that the loads on the entire shaft sealing structure can be balanced.

### CROSS-REFERENCE TO RELATED APPLICATIONS

The present invention claims benefit and priority of Taiwanese Patent Application No. TW 103121660, filed on Jun. 24, 2014, which is herein incorporated by reference in its entirety.

### BACKGROUND OF THE INVENTION

1. Technical Field

The present invention relates to a fluid valve, and more particularly to a fluid valve having a shaft sealing structure.

2. Description of the Prior Art

A fluid valve is provided on a fluid channel, as shown in FIG. 1A. The fluid valve provided on the fluid channel includes a valve body 92, in which a shaft 94 and a valve disc (not shown) are installed. By moving, rotating or pulling the shaft 94, the valve disc (not shown) is displaced in sync with the shaft 94, such that the channel is opened or closed to control the flow in the channel.

In industrial application of fluid valves, the valve body and shaft need to be resistant to high-temperature, solvent or corrosive fluids, and therefore are often made of heat-resistant, indissoluble materials, such as metals. Nevertheless, since metals become worn as they have contacted each other for a long time, and metal normally have larger thermal expansion coefficients, gaps are easily created between the shaft and the valve body, or the shaft may easily be stuck in the valve body. Accordingly, in a common fluid valve, a shaft seal groove 922 is formed between the shaft 94 and the valve body 92, and several annular shaft seal rings 96 are placed in the shaft seal groove 922, such that a sealing structure for the shaft 94 is formed. The shaft seal rings 96 are often made of softer materials with smaller thermal expansion coefficients, such as graphite. As such, the jamming of the shaft 94 and the valve body 92 due to wear or drastic expansion and contraction may be reduced. Please refer to FIG. 1B, for a common shaft sealing structure of the fluid valve, the load distribution 8 on the shaft seal rings 96 is unbalanced in the top-down direction, wherein the upper portion of the shaft seal rings 96 is subjected to a larger load than the lower part thereof, and such result may affect the sealing degree of the shaft sealing structure. In an Ideal load distribution, the upper and lower ends are subjected to similar loads, and the loads decrease when approaching the center portion. That is, under an ideal condition, both ends of the shaft seal rings 96 are subjected to similar forces. For addressing the issue of unbalanced loads, some valve bodies have been known to be provided with disc springs or coil springs in the sealing structure for balancing loads. However, due to the structure of disc springs, there exists a problem that the inner and outer rings of a disc spring apply forces unequally, and the issue of unbalanced loads therefore cannot be effectively fixed. Coil springs apply forces evenly, but they occupy too much space.

In addition, in a case that the fluid valve has been used for a long period of time, if wastage occurs to the shaft seal rings 96 due to wear or corrosion by fluid, gaps may be created between the shaft 94 and the valve body 92, fluid thereby may leak via the gaps.

Thus, the shaft seal rings 96 within the shaft seal groove 922 need to be periodically cleaned and replaced for maintaining the normal operation of the fluid valve. However, as can be seen from FIG. 1A, in a case that the shaft seal groove 922 is a cramped space, it is difficult to clean or replace the shaft seal rings 96. Since the cleaning takes a lot of time and work, cost of labor will increase, and additional loss e.g. production lines shutdowns, may be caused by unavailable fluid valves.

In view of this, it is an urgent objective to be achieved to provide a shaft sealing structure, which can solve the problem of unbalanced loads, as well as having advantages of cleaning convenience and small space occupation.

### SUMMARY OF THE INVENTION

In order to solve the abovementioned problem, a major objective of the present invention is to provide a fluid valve with a sealing structure that produces pushing forces in the shaft seal groove, so that gaps will not occur to the shaft seal ring due to wastage, and the sealing structure can be rapidly replaced when the shaft seal ring or other shaft seal components are badly worn.

Another objective of the present invention is to provide a fluid valve with a sealing structure, wherein the spring in the module is able to continuously provide pushing forces, so that gaps will be less prone to occur to the shaft seal components between the shaft and the valve body, and leakage of fluid from the gaps can be prevented.

Still another major objective of the present invention is to provide a fluid valve with a sealing structure, wherein an old module can be withdrawn with a new one inserted when a worn shaft seal component needs to be replaced, so that the maintenance time for the fluid valve can be reduced, and cost of labor or loss caused by shutdowns can be minimized.

Yet another major objective of the present invention is to provide a fluid valve with a sealing structure, wherein the inner surface and outer surface of the shaft ring are respectively provided with opposing inner groove and outer groove, resulting in an H-shaped cross section of the shaft ring. Such structure renders the shaft ring advantageous in being not prone to be deformed. In addition, the inner groove and outer groove of the shaft ring are respectively provide an O-ring, so that the shaft ring has strength and keeps a tight sealing with the wall.

According to the requirements above, the present invention provides a fluid valve comprising a valve body, a shaft, a valve disc and a shaft sealing structure. The valve body has a first accommodating space and a second accommodating space. The first accommodating space is located above the second accommodating space and in communication with the second accommodating space. The shaft sealing structure has a third accommodating space and is provided in the first accommodating space. The valve disc is provided in the second accommodating space. The shaft is provided in the third accommodating space and in connection with the valve disc, so that the valve disc can be actuated by controlling the shaft. The shaft sealing structure comprises: a plurality of shaft seal rings provided on the bottom of the first accommodating space in a stacked manner; a shaft ring provided above the plurality of shaft seal rings; and a spring which is ring-shaped and provided above the shaft ring, the spring having a continuously wave-shaped surface with multiple peaks and multiple valleys, the valleys engaging the shaft ring, wherein the inner sides of the plurality of shaft seal rings, the shaft ring and the spring are combined to enclose the third accommodating space.

The present invention further provides a fluid valve comprising a valve body, a shaft, a valve disc and a shaft sealing structure. The valve body has a first accommodating space and a second accommodating space. The first accommodating space is in communication with the second accommodating space. The shaft sealing structure has a third accommodating space and is provided in the first accommodating space. The valve disc is provided in the second accommodating space. The shaft is provided in the third accommodating space and in connection with the valve disc, so that the valve disc can be actuated by controlling the shaft. The shaft sealing structure comprises: a plurality of first shaft seal rings provided on the bottom of the first accommodating space in a stacked manner; a first shaft ring provided above the plurality of first shaft seal rings; a spring which is ring-shaped and provided above the first shaft ring, the spring having a continuously wave-shaped surface with multiple peaks and multiple valleys, the valleys engaging the first shaft ring; a second shaft ring provided above the spring and engaging the peaks; and a plurality of second shaft seal rings provided above the second shaft ring in a stacked manner, wherein the inner sides of the plurality of first shaft seal rings, the plurality of second shaft seal rings, the first shaft ring, the second shaft ring and the spring are combined to enclose the third accommodating space.

### BRIEF DESCRIPTION OF THE DRAWINGS

FIG. 1A is a cross-sectional view illustrating a shaft sealing structure of a conventional fluid valve;

FIG. 1B is a schematic view illustrating the load distribution for the shaft sealing structure of the conventional fluid valve;

FIG. 2 is a structural schematic view illustrating a fluid valve with a modular shaft sealing structure, in accordance with the present invention;

FIG. 3A is a partial enlarged cross-sectional view illustrating a modular shaft sealing structure of a fluid valve according to a first embodiment of the present invention;

FIG. 3B is a partial exploded schematic view illustrating the modular shaft sealing structure according to the present invention;

FIG. 3C is a partial enlarged cross-sectional view illustrating a modular shaft sealing structure of a fluid valve according to a second embodiment of the present invention;

FIG. 4A is a schematic view illustrating the load distribution for the modular shaft sealing structure of the fluid valve according to the first embodiment of the present invention;

FIG. 4B is a schematic view illustrating the load distribution for the modular shaft sealing structure of the fluid valve according to the second embodiment of the present invention;

FIG. 5 is a separated schematic view illustrating the modular shaft sealing structure and a valve body of the fluid valve according to the present invention;

FIG. 6 is a cross-sectional view illustrating a modular shaft sealing structure of a fluid valve according to a third embodiment of the present invention; and

FIG. 7 is a schematic view illustrating the load distribution for the modular shaft sealing structure of the fluid valve according to the third embodiment of the present invention.

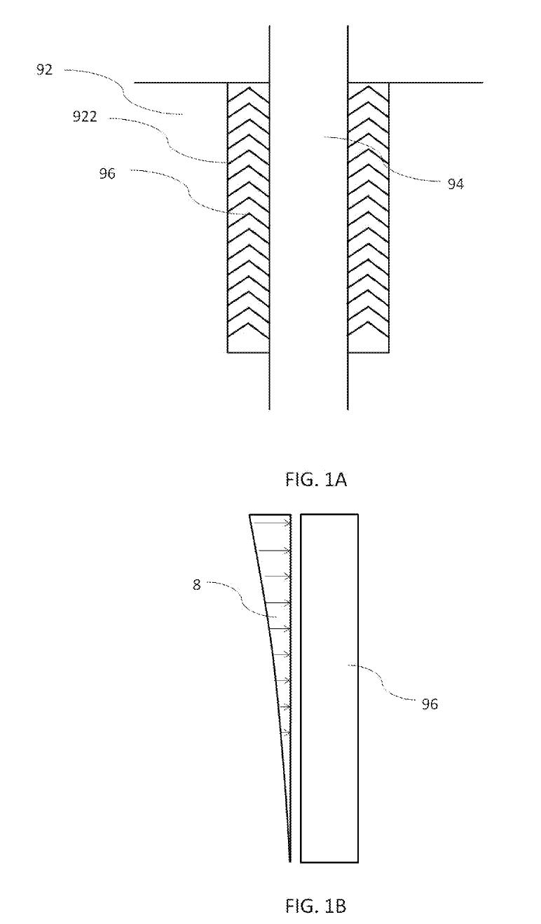

### DETAILED DESCRIPTION OF THE PREFERRED EMBODIMENTS

The present invention discloses a fluid valve with a modular shaft sealing structure, characterized by the modular shaft sealing structure. Therefore, the following description of the present invention does not illustrate the details of the other components in the fluid valve, but those skilled in the art will still understand the operational principles of the present invention. In addition, it is intended that the reference drawings of the present invention schematically present structures related to the technical features of the present invention, and is not necessarily drawn to scale.

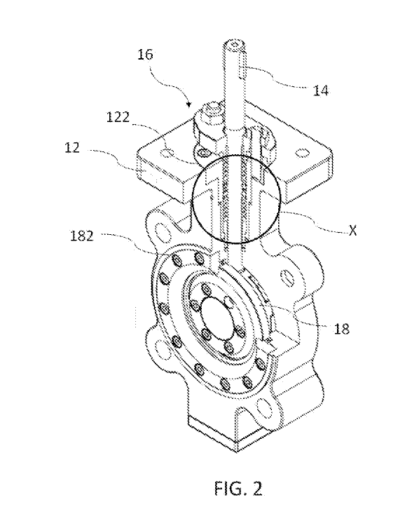

Please refer to FIG. 2, which is a structural schematic view illustrating a fluid valve 1 with a modular shaft sealing structure 16, in accordance with the present invention. As shown in FIG. 2, the fluid valve 1 includes a valve body 12, a shaft 14 and a valve disc 18. The shaft 14 and valve disc 18 are installed within the valve body 12 and connected to each other. The fluid valve 1 is disposed on a fluid channel (not shown), and the valve disc 18 is configured on the cross section of the fluid channel. The valve disc 18 can be driven through the operation of the shaft 14, thereby controlling the opening and closure of the fluid channel. As shown in FIG. 2, the valve body includes a shaft seal groove 122 and a valve disc groove 182. The shaft seal groove 122 and the valve disc groove 182 are two accommodating spaces in communication with each other. In the present embodiment, the valve disc groove 182 is located below the shaft seal groove 122, wherein the modular shaft sealing structure 16 and the shaft 14 are both installed in the shaft seal groove 122 of the valve body 12, the modular shaft sealing structure 16 is positioned between the shaft 14 and the shaft seal groove 122, and the valve disc 18 is provide in the valve disc groove 182. Details of the modular shaft sealing structure 16 will be thoroughly described later.

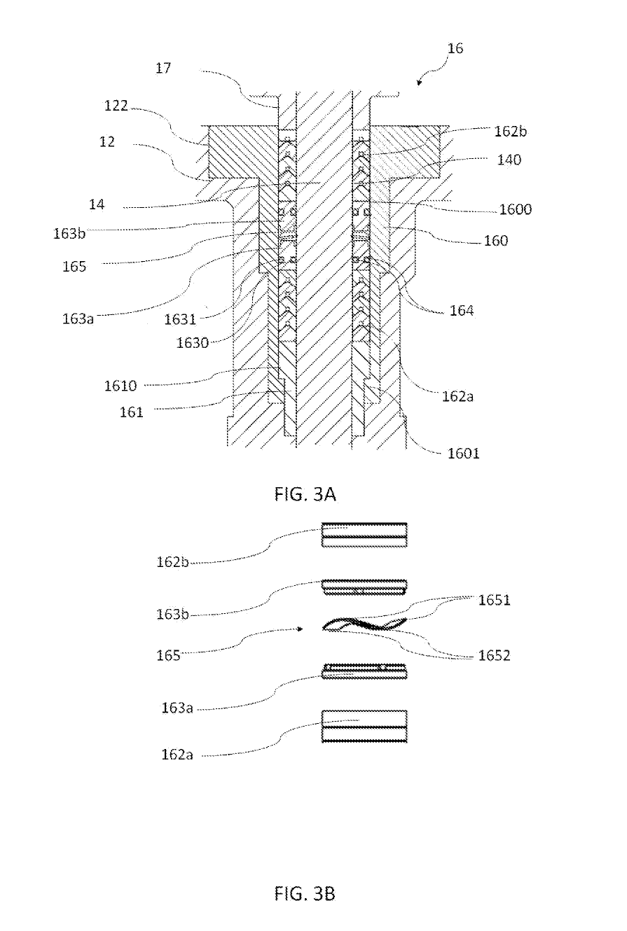

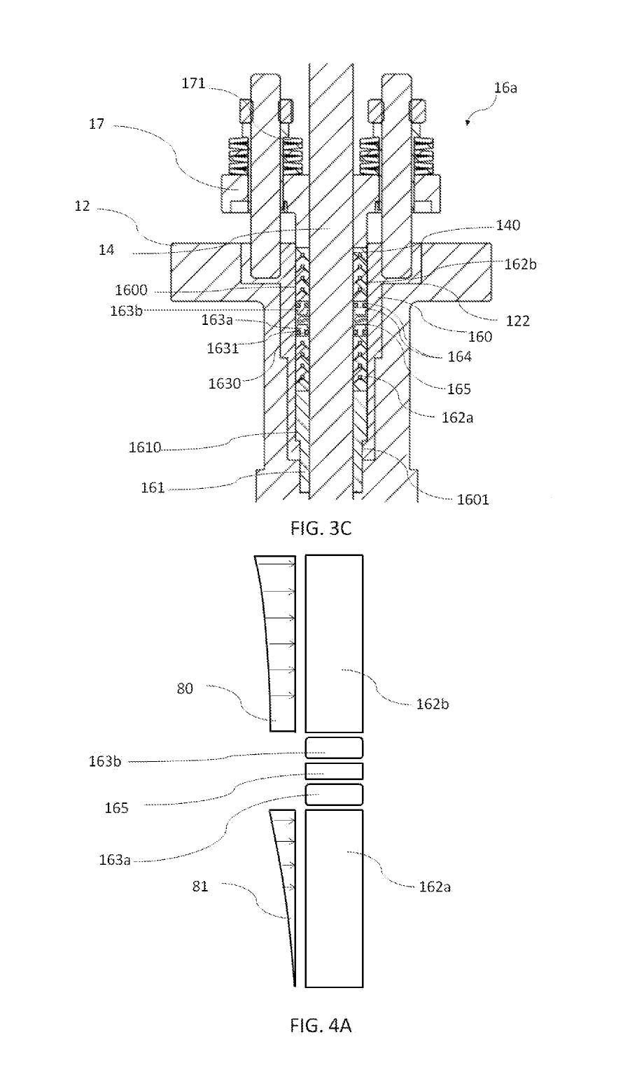

Please refer to FIG. 2 and FIG. 3A, where FIG. 3A is a structural cross-sectional view illustrating the modular shaft sealing structure 16 according to a first embodiment of the present invention. FIG. 3A can be obtained by taking a cross section at the circle x shown in FIG. 2. As shown in FIG. 2, the modular shaft sealing structure 16 is installed in the shaft seal groove 122 of the valve body 12. The shaft seal groove 122 is an accommodating space extending from the upper end of the valve body 12 down through a region where the valve disc 18 is located, and is configured for the installation of the modular shaft sealing structure 16. The modular shaft sealing structure 16 includes at least a carrier 160, a liner 161, shaft seal rings 162a and 162b, shaft rings 163a and 163b and a spring 165. The lower end of the shaft seal groove 122 is an end close to the valve disc 18. An accommodation space 1600 penetrates the upper and lower ends of the carrier 160. The inner edge of the lower end of the carrier 160 is provided with a projecting confinement section 1601. The carrier 160 is placed in the shaft seal groove 122 with its lower end facing the valve disc 18, and the lower end of the carrier 160 is therefore adjacent to the valve disc 18. In an embodiment, from the bottom up, at least a liner 161, a plurality of shaft seal rings 162a, a shaft ring 163a and a spring 165 are sequentially provided within the accommodating space 1600. In a more preferred embodiment, a shaft ring 163b and a plurality of shaft seal rings 162b may be further provided above the spring 165, forming a shaft sealing structure which is longitudinally symmetric.

The liner 161 has a hollow columnar body. It is disposed at the lower end in the accommodation space 1600 of the carrier 160, and is also adjacent to the valve disc 18. The outer edge of the upper end of the liner 161 is provided with a projecting confinement section 1610. The lower edge of the confinement section 1610 and the upper edge of the confinement section 1601 of the carrier 160 rest against each other, so that the liner 161 can be disposed at the bottom of the accommodation space 1600 of the carrier 160, with a portion of the liner 161 projecting from the lower end of the carrier 160. In another embodiment, the liner 161 and the carrier 160 are integrally formed, or the carrier 160 and the liner 161 are one-piece formed.

As mentioned above, in the accommodating space 1600, the plurality of shaft seal rings 162a, the shaft ring 163a, the spring 165, the shaft ring 163b and the plurality of shaft seal rings 162b are sequentially configured above the liner 161, wherein the inner and outer surfaces of the shaft rings 163a and 163b are provided with corresponding inner groove 1630 and outer groove 1631, respectively. Thus, the shaft rings 163a and 163b are H-shaped in cross section. With such structure, the shaft rings 163a and 163b are advantageous in being not prone to be deformed. Each of the inner groove 1630 and outer groove 1631 of the shaft rings 163a and 163b is provide with and O-ring 164, which provides the shaft rings 163a and 163b stronger structures and maintains a tight sealing with the walls of the carrier 160 and shaft 140.

The shaft seal rings 162a and 162b, the shaft rings 163a and 163b, and the spring 165 are annular. The inner diameter of the liner 161 is consistent with these components. Apparently, the inner edges of these stacked components will join together and construct an accommodating space 140. Each of the upper and lower ends of the accommodating space 140 is provided with an opening, which allows the shaft 14 to be accommodated in the accommodating space 140. The shaft 14 is inserted from the upper opening of the accommodating space 140 at the upper end of the carrier 160, through the accommodating space 140, and exists from the lower opening of the accommodating space 140 and the lower end of the carrier 160, so as to be connected to the valve disc 18. The shaft 14 further includes a cap 17. When the shaft 14 is installed in the accommodating space 140, the cap 17 will cover the upper opening of the accommodating space 1600 at the upper end of the carrier 160 (i.e., cover the opening of the accommodating space 1600 at the end of the carrier 160 away from the valve disc 18), and the carrier 160 is fixed to the cap 17, such that components e.g. the shaft seal rings 162a and 162b, the shaft rings 163a and 163b, and the spring 165 are sealed in the accommodating space 1600. Moreover, the cap 17 is provided at the end of the carrier 160 away from the valve disc 18. In the aforementioned embodiment, the spring 165 may be a wave spring, and the shaft seal rings 162a and 162b are compressible materials, such as graphite.

In this embodiment, if the spring 165 is a wave spring as shown in FIG. 3B, the spring 165 has a continuously wave-shaped surface, and at least comprises a plurality of peaks 1651 and a plurality of valleys 1652. When the spring 165 is stacked together with the shaft rings 163a and 163b, the peaks 1651 of the spring 165 contact the shaft ring 163b, and the valleys 1652 of the spring 165 contact the shaft ring 163a. Due to their structure, wave springs have advantages of little occupation or saving space compared to coil springs, and advantages of long active distance and uniform force application compared to disc springs.

As shown in FIG. 3C, in the case of the modular shaft sealing structure 16a of the fluid valve according to a second embodiment of the present invention, a spring 171 is disposed above the cap 17. The spring 171 applies downward forces to the cap 17, enabling the cap 17 to apply downward forces to the carrier 160 and components in the carrier 160. The components in the modular shaft sealing structure 16a are thereby combined more tightly. In the present embodiment, the spring 171 is a disc spring, but the type of the spring 171 is not limited thereto.

Compared to common shaft sealing structures, the aforementioned shaft sealing structures 16 and 16a are additionally provided with the spring 165 and shaft rings 163a and 163b. The spring 165 can vertically push other components. Therefore, when other annular components around the shaft 14 are worn after being used for a long time, the pushing force of the spring 165 will squeeze those annular components, and those squeezed components slightly deform, thereby prevent gaps from presenting between the shaft 14 and the carrier 160 due to the wear. Thus, the effect of balancing the loads of the shaft sealing structure can be achieved.

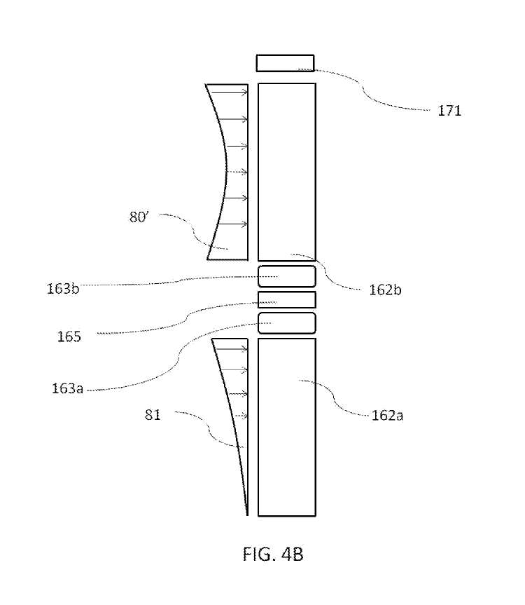

As shown in FIG. 4A, the spring 165 between the two shaft seal rings 162a and 162b effectively enables the load distributions 80 and 81 to be closer to an ideal condition and reduces the difference between the loads of the upper shaft seal ring 162a and the lower shaft seal ring 162a. In the aforementioned embodiment, shaft rings 163b and 163a, which are respectively located at the upper and lower end of the spring 165, are made of harder materials. When the spring 165 applies forces to the shaft rings 163b and 163a, the shaft rings will not easily deform due to these forces, so that the spring 165 applies the forces evenly. As shown in FIG. 4B, in the modular shaft sealing structure 16a, the forces applied by the spring 171 enable the load distribution 80′ supported by the shaft seal ring 162b above the spring 165 to be closer to an ideal condition.

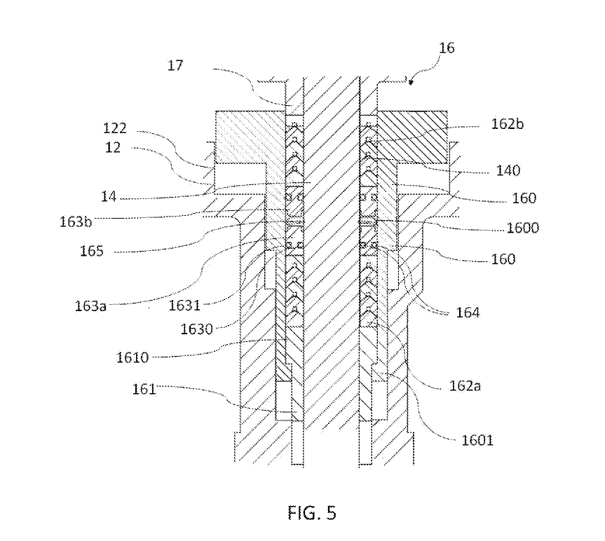

Next, please refer to FIG. 3A and FIG. 5. FIG. 5 is a separated schematic view illustrating the modular shaft sealing structure 16 and the valve body of the fluid valve according to the present invention. As mentioned earlier with reference to FIG. 3A, a plurality of components are installed in the accommodating space 1600 of the carrier 160. As shown in FIG. 5, the carrier 160 can be removed upward from the shaft seal groove 122. When the carrier 160 is withdrawn upward, the confinement section 1601 of the carrier 160 and the confinement section 1610 of the liner 161 rest against each other, the liner 161 is therefore withdrawn upward together with the carrier 160, and the shaft seal rings 162a and 162b, the shaft rings 163a and 163b, and the spring 165 are withdrawn as well. As a result, the entire shaft sealing structure 16 can be withdrawn from the shaft seal groove 122 along the side surface of the shaft 14, and separated from the valve body 12 of the fluid valve 1. Accordingly, comparing the fluid valve 1 with the modular shaft sealing structure 16 to conventional fluid valves, the modular shaft sealing structure 16 of the present invention is detachable and integrally replaceable, and can therefore provide convenience in maintaining.

In another embodiment, the modular shaft sealing structure 16 in the fluid valve 1 of the present invention may not be provided with the shaft rings 163a and 163b and spring 165. In such embodiment, the modular shaft sealing structure 16 can still be detached from the fluid valve 1 and replaced.

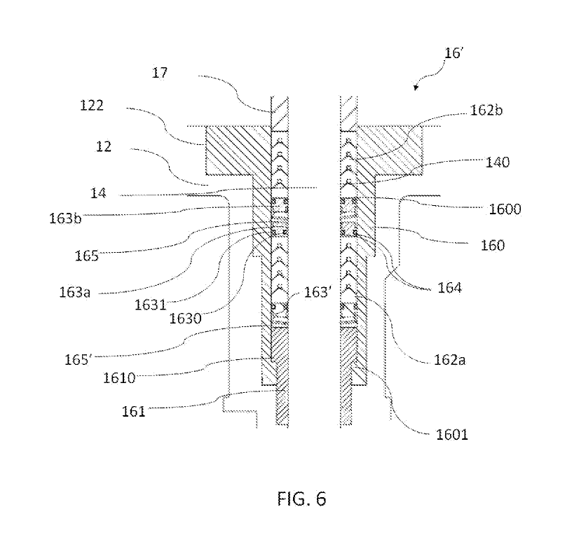

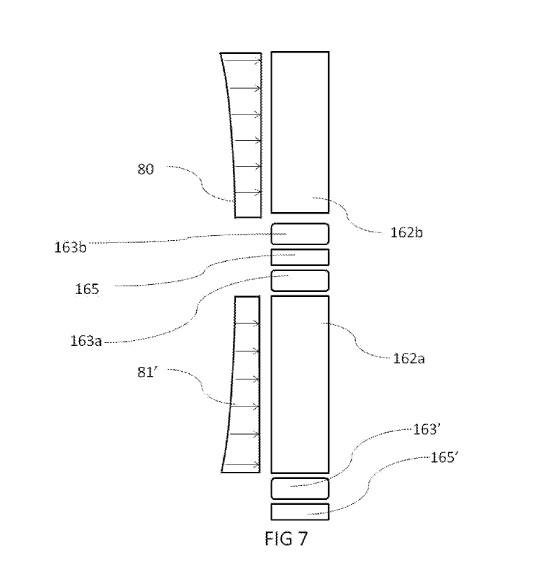

Next, please refer to FIG. 6, which is a cross-sectional view illustrating a modular shaft sealing structure 16′ of a fluid valve according to a third embodiment of the present invention. In this embodiment, the constituent components and component configurations of the modular shaft sealing structure 16′ are similar to those of the modular shaft sealing structure 16 shown in FIG. 3A. The difference therebetween is that a spring 165′ and a shaft ring 163′ are further provided between the liner 161 and shaft seal ring 162a of the modular shaft sealing structure 16′, wherein the spring 165′ is provided above the liner 161, the shaft ring 163′ is above the spring 165′, and the shaft seal ring 162a, shaft ring 163a, spring 165, shaft ring 163b and shaft seal ring 162b, which are identical to those in the modular shaft sealing structure 16, are sequentially provided above the shaft ring 163′. The configuration of these components is the same as that of the components in the modular shaft sealing structure 16, so it will not be described in detail again. In this embodiment, second spring 165′ and shaft ring 163′ are used. Thus, in the modular shaft sealing structure 16′ shown in FIG. 7, the load distributions 80 and 81′ supported by the shaft seal rings 162a and 162b are more balanced, and the force supported by the upper end of the shaft seal ring 162b is similar to that supported by the lower end of the shaft seal ring 162a. In addition, the spring 165′ may be a wave spring which has a similar structure as the spring 165 in FIG. 3B, and will not be described in detail again.

It should be noted that, in the case of using a fixed shaft sealing structures 16, 16′ or 16a in the fluid valve 1 of the present invention instead of a detachable modular shaft sealing structure, the shaft sealing structure 16, 16′ or 16a in the fluid valve 1 may not include the carrier 160 and the liner 161. In such case, the shaft sealing structure 16, 16′ or 16a is constructed by the shaft seal rings 162a and 162b, the shaft rings 163a and 163b, and the spring 165. In this embodiment, the shaft sealing structure 16, 16′ or 16a still produces effect of load balancing although it cannot be integrally from the fluid valve 1 and replaced.

According the modular shaft sealing structures 16, 16′ and 16a of the fluid valve 1 provided by the present invention, the springs 165, 165′ and the shaft rings 163a, 163b and 163′ enable the loads on the sealing structure around the shaft 14 to be balanced in the fluid valve 1. Therefore, the modular shaft sealing structures 16, 16′ and 16a enable respective components to be combined more tightly. Also, In a case that gaps present due to the wearing of respective components after being used for a long time, the modular shaft sealing structures 16, 16′ and 16a can produce pushing forces for making the components slightly deformed to fill the gaps, so as to reduce fluid leakage through the gaps between the shaft 14 and the valve body 12.

According to the present invention, the modular shaft sealing structure 16, 16′ or 16a of the fluid valve may be taken out of the shaft seal groove 122, and further separated from the valve body 12 of the fluid valve. Thus, technicians maintaining the fluid valve 1 can easily remove and renew components in the carrier 160, or even place a modular shaft sealing structure 16, 16′ or 16a in the shaft seal groove 122 after removing another modular shaft sealing structure 16, 16′ or 16a. This will significantly reduce the maintenance time for the fluid valve 1. Also, the carrier 160 is reusable after the components carried therein are removed, so as to be environment friendly.

Additionally, while the fluid valve 1 exemplarily shown in FIG. 2 is a butterfly valve, the modular shaft sealing structure 16 of the present invention is not necessarily used on a specific type of fluid valve. The fluid valve 1 of the present invention may be a globe valve, a ball valve, or any other valves used for fluids, and is not limited in the present invention.

The abovementioned are merely preferred embodiments of the present invention, and shall not be used to limit the scope of the appended claims. Further, those skilled in the art will understand from the description set forth, and practice the present invention according thereto. Thus, other equivalent alterations and modifications which are completed without departing from the spirit disclosed by the present invention should be included in the scope of the appended claims.

What is claimed is:

1. A fluid valve comprising a valve body, a shaft, a valve disc and a shaft sealing structure, the valve body having a first accommodating space and a second accommodating space, the first accommodating space being located above the second accommodating space and in communication with the second accommodating space, the shaft sealing structure having a third accommodating space and being provided in the first accommodating space, the valve disc being provided in the second accommodating space, the shaft being provided in the third accommodating space and in connection with the valve disc, so that the valve disc is actuated by controlling the shaft, wherein the shaft sealing structure comprises:
a plurality of shaft seal rings provided on the bottom of the first accommodating space in a stacked manner;
a shaft ring provided above the plurality of shaft seal rings; and
a spring which is ring-shaped and provided above the shaft ring, the spring having a continuously wave-shaped surface with multiple peaks and multiple valleys, the valleys engaging the shaft ring,
wherein the inner sides of the plurality of shaft seal rings, the shaft ring and the spring are combined to enclose the third accommodating space.

2. The fluid valve of claim 1, further comprising a cap, which is provided above the modular shaft sealing structure, and covers an opening on an end of the third accommodating space away from the valve disc, so as to seal the shaft, the shaft seal rings, the shaft ring and the spring within the third accommodating space.

3. The fluid valve of claim 2, wherein a spring is provided above the cap.

4. The fluid valve of claim 1, wherein two opposing grooves are provided on the inner surface and the outer surface of the shaft ring, respectively, and an O-ring is disposed in each of the grooves.

5. The fluid valve of claim 1, wherein the inner diameters of the shaft seal rings, the shaft ring and the spring are substantially the same.

6. The fluid valve of claim 1, wherein the fluid valve is a globe valve, a ball valve, or a butterfly valve.

7. A fluid valve comprising a valve body, a shaft, a valve disc and a shaft sealing structure, the valve body having a first accommodating space and a second accommodating space, the first accommodating space being in communication with the second accommodating space, the shaft sealing structure having a third accommodating space and being provided in the first accommodating space, the valve disc being provided in the second accommodating space, the shaft being provided in the third accommodating space and in connection with the valve disc, so that the valve disc is actuated by controlling the shaft, wherein the shaft sealing structure comprises:
a plurality of first shaft seal rings provided on the bottom of the first accommodating space in a stacked manner;
a first shaft ring provided above the plurality of first shaft seal rings;
a spring which is ring-shaped and provided above the first shaft ring, the spring having a continuously wave-shaped surface with multiple peaks and multiple valleys, the valleys engaging the first shaft ring;
a second shaft ring provided above the spring and engaging the peaks; and
a plurality of second shaft seal rings provided above the second shaft ring in a stacked manner,
wherein the inner sides of the plurality of first shaft seal rings, the plurality of second shaft seal rings, the first shaft ring, the second shaft ring and the spring are combined to enclose the third accommodating space.

8. A fluid valve comprising a valve body, a shaft, a valve disc and a shaft sealing structure, the valve body having a first accommodating space and a second accommodating space, the first accommodating space being located above the second accommodating space and in communication with the second accommodating space, the modular shaft sealing structure having a third accommodating space and being provided in the first accommodating space, the valve disc being provided in the second accommodating space, the shaft being provided in the third accommodating space and in connection with the valve disc, so that the valve disc is actuated by controlling the shaft, wherein the shaft sealing structure comprises:
a first spring which is ring-shaped and provided on the bottom of the first accommodating space, the first spring having a continuously wave-shaped surface with multiple peaks and multiple valleys;
a first shaft ring provided above the first spring, the peaks of the first spring engaging the first shaft ring;
a plurality of first shaft seal rings provided above the first shaft ring in a stacked manner;
a second shaft ring provided above the plurality of first shaft seal rings;
a second spring which is ring-shaped and provided above the second shaft ring, the second spring having a continuously wave-shaped surface with multiple peaks and multiple valleys, the valleys of the second spring engaging the second shaft ring;
a third shaft ring provided above the second spring, the third shaft ring engaging the peaks of the second spring; and
a plurality of second shaft seal rings provided above the third shaft ring in a stacked manner,
wherein the inner sides of the plurality of first shaft seal rings, the plurality of second shaft seal rings, the first shaft ring, the second shaft ring, the third shaft ring, the first spring and the second spring are combined to enclose the third accommodating space.
